(19) United States
(12) Patent Application Publication
(10) Pub. No.: US 2005/0157194 A1
(43) Pub. Date: Jul. 21, 2005

(54) Imager device with dual storage nodes

(76) Inventor: Peter Parker Altice JR., Meridian, ID (US)

Correspondence Address: DICKSTEIN SHAPIRO MORIN & OSHINSKY LLP, 2101 L Street, NW, Washington, DC, 20037, US

(21) Appl. No.: 10/751,440

(22) Filed: Jan. 6, 2004

(51) Int. Cl. H04N 5/335

(52) U.S. Cl. 348/308

(57) ABSTRACT

An improved pixel cell is disclosed for use in an imager device, the pixel cell having increased signal to noise ratios, and a larger charge storage capacity. Each pixel cell contains two storage nodes in parallel with each other and also in series with the floating diffusion region. During applications requiring lower storage capacity, one of the storage nodes is activated. During applications requiring higher storage capacity, the second storage node is activated sequentially after the first storage node is activated. Thereafter, the full charge stored by both storage nodes is read out by the pixel readout circuit. Further, in accordance with an exemplary embodiment of the invention, one of the storage nodes is obtained by an additional transfer gate and diffusion node connected to a physical capacitor within the pixel cell and the other storage node is formed by a storage gate covering an additional depletion area between the photodiode and the floating diffusion region.

### FIELD OF THE INVENTION

The present invention relates generally to complementary metal oxide semiconductor (CMOS) imagers, and more particularly to a CMOS imager pixel having two storage nodes in addition to a floating diffusion region.

### BACKGROUND OF THE INVENTION

An imager, for example, a CMOS imager includes a focal plane array of pixel cells; each cell includes a photosensor, for example, a photogate, photoconductor or a photodiode overlying a substrate for producing a photo-generated charge in a doped region of the substrate. A readout circuit is provided for each pixel cell and includes at least a source follower transistor and a row select transistor for coupling the source follower transistor to a column output line. The pixel cell also typically has a floating diffusion region, connected to the gate of the source follower transistor. Charge generated by the photosensor is sent to the floating diffusion region. The pixel cell may also include a transistor for transferring charge from the photosensor to the floating diffusion region. The pixel cell also typically includes a transistor to reset the floating diffusion region.

FIG. 1 illustrates a block diagram of a conventional CMOS imager device 908 having a pixel array 200 with each pixel cell being constructed as described above. Pixel array 200 comprises a plurality of pixels arranged in a predetermined number of columns and rows. The pixels of each row in array 200 are all turned on at the same time by a row select line, and the pixels of each column are selectively output by respective column select lines. A plurality of row and column lines are provided for the entire array 200. The row lines are selectively activated in sequence by the row driver 210 in response to row address decoder 220 and the column select lines are selectively activated in sequence for each row activated by the column driver 260 in response to column address decoder 270. Thus, a row and column address is provided for each pixel.

The CMOS imager 908 is operated by the control circuit 250, which controls address decoders 220, 270 for selecting the appropriate row and column lines for pixel readout, and row and column driver circuitry 210, 260, which apply driving voltage to the drive transistors of the selected row and column lines. The pixel output signals typically include a pixel reset signal, Vᵣₛₜ taken off the floating diffusion region when it is reset and a pixel image signal, V_{sig}, which is taken off the floating diffusion region after charges generated by an image are transferred to it. The Vᵣₛₜ and V_{sig} signals are read by a sample and hold circuit 265 and are subtracted by a differential amplifier 267 that produces a signal Vᵣₛₜ-V_{sig} for each pixel, which represents the amount of light impinging on the pixels. This difference signal is digitized by an analog to digital converter 275. The digitized pixel signals are then fed to an image processor 280 to form a digital image. The digitizing and image processing can be performed on or off the chip containing the pixel array.

FIG. 2 depicts a schematic diagram of a conventional pixel cell 300, as incorporated in the FIG. 1 imager device 908. Photodiode 302 is coupled between ground and a source/drain terminal of transfer transistor 310. Another source/drain terminal of transfer transistor 310 is coupled to floating diffusion region 322. The floating diffusion region 322 is coupled to both a reset transistor 314 and a source-follow transistor 320. Both the reset transistor 314 and the source-follower transistor 320 are coupled to a system voltage terminal (e.g., Vcc). The source follower transistor 320 is also coupled to row select transistor 318, which is coupled to the column line 355.

During operation, the floating diffusion region 322 is reset to Vcc and the pinned photodiode 302 is reset to a pin potential Vpin (not shown). At this point, integration of the pinned photodiode 302 begins. Following integration, the floating diffusion region 322 is reset and the reset voltage on the floating diffusion region 322 is read out via source-follower transistor 320 and row select transistor 318, to a sample and hold circuit 265, as described in connection with FIG. 1. Following the readout of the reset voltage on the floating diffusion region 322, the charge generated by the photodiode 302 is transferred, via the transfer transistor 310 to the floating diffusion region 322, where it is also read out and forwarded to the sample and hold circuit 265.

Imager pixels, including CMOS imager pixels typically have low signal to noise ratios and narrow dynamic range because of their inability to fully collect, transfer and store the electric charge collected by the photosensitive area of the photodiode 302. Since the resultant size of the pixel electrical signal is very small, the signal to noise ratio and dynamic range of the pixel should be as large as possible. In addition, customer demands increasingly call for applications requiring higher dynamic range.

The use of additional gates, however, to increase the functional operations of the pixel (i.e., electronic shuttering) increases the size of the pixel or reduces the fill factor of the pixel. There is needed, therefore, an improved pixel cell for use in an imager having increased signal to noise ratios, and a larger charge storage capacity.

### BRIEF SUMMARY OF THE INVENTION

The present invention addresses the shortcoming described above and provides an improved pixel cell for use in an imager device, each pixel cell having increased signal to noise ratios, and a larger charge storage capacity. Each pixel cell contains two storage nodes in parallel with each other and in series with the floating diffusion region. During applications requiring lower storage capacity, one of the storage nodes is activated. However, during applications requiring higher storage capacity, the second storage node is activated sequentially after the first storage node is activated. The full charge stored by both storage nodes is read out by the pixel readout circuit. Further, in accordance with an exemplary embodiment of the invention, one of the storage nodes is obtained by an additional transfer gate and diffusion node connected to a physical capacitor within the pixel cell and the other storage node is formed by a storage gate covering an additional depletion area between the photodiode and the floating diffusion region.

### BRIEF DESCRIPTION OF THE DRAWINGS

The above and other features and advantages of the invention will be more readily understood from the following detailed description of the invention which is provided in connection with the accompanying drawings, in which:

FIG. 1 depicts a block diagram of a conventional CMOS imager device;

FIG. 2 depicts a schematic diagram of a conventional pixel cell;

FIG. 3 depicts a schematic diagram of a pixel cell having dual storage nodes, in accordance with an exemplary embodiment of the invention;

FIG. 4 depicts a schematic diagram of a pixel cell having dual storage nodes, in accordance with another exemplary embodiment of the invention;

FIG. 5 depicts a timing diagram describing an image capture operation of the FIG. 4 pixel cell, in accordance with an exemplary embodiment of the invention;

FIG. 6 depicts a timing diagram describing a readout operation of the FIG. 4 pixel cell, in accordance with another exemplary embodiment of the invention;

FIG. 7 depicts a plan view of the FIG. 4 pixel cell, in accordance with another exemplary embodiment of the invention;

FIG. 8 depicts a plan view of two pixel cells, in accordance with another exemplary embodiment of the invention;

FIG. 9 depicts a sample and hold circuit, in accordance with another exemplary embodiment of the invention;

FIG. 10 depicts a sample and hold circuit, in accordance with another exemplary embodiment of the invention;

FIG. 11 depicts a sample and hold circuit, in accordance with another exemplary embodiment of the invention; and

FIG. 12 depicts a processor system, in accordance with another exemplary embodiment of the invention.

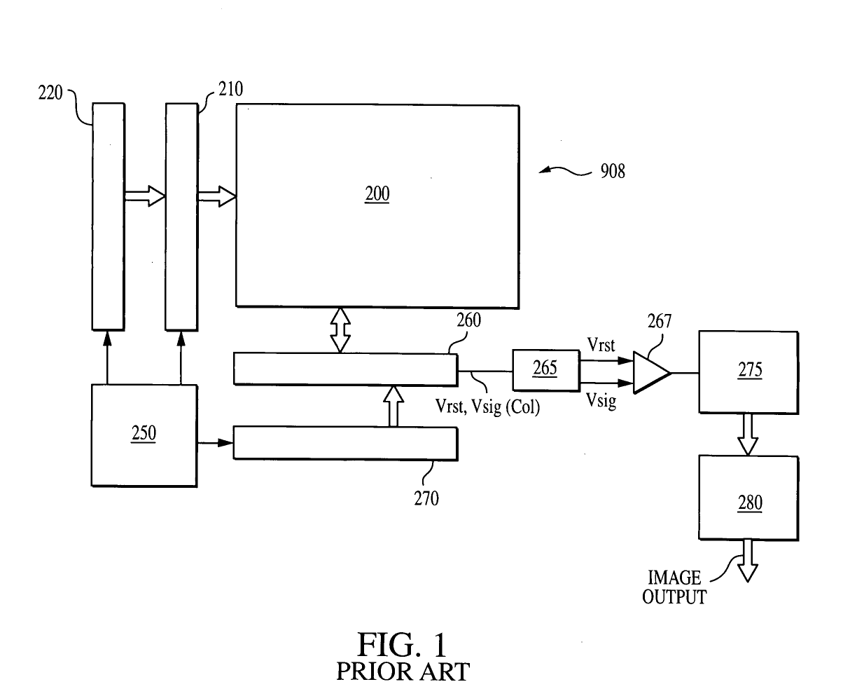

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those of ordinary skill in the art to make and use the invention, and it is to be understood that structural, logical or procedural changes may be made to the specific embodiments disclosed without departing from the spirit and scope of the present invention.

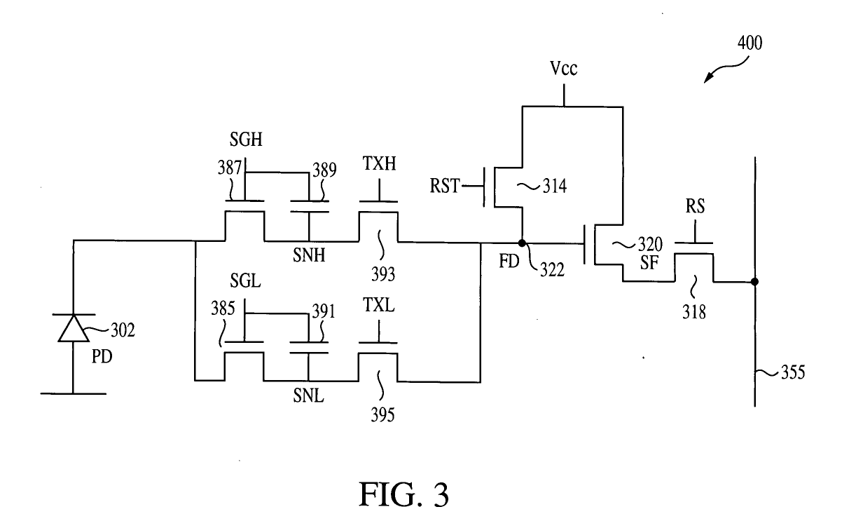

FIG. 3 depicts a schematic diagram of a pixel cell 400, in accordance with an exemplary embodiment of the invention. The pixel cell 400 consists of a photosensitive element (e.g., a photodiode) 302 coupled to both a first shutter gate transistor 387 and a second shutter gate transistor 385. The first shutter gate transistor 387 is configured to be conducting upon receiving a shutter gate high (SGH) signal and the second shutter gate transistor 385 is configured to be conducting upon receiving a shutter gate low (SGL) signal.

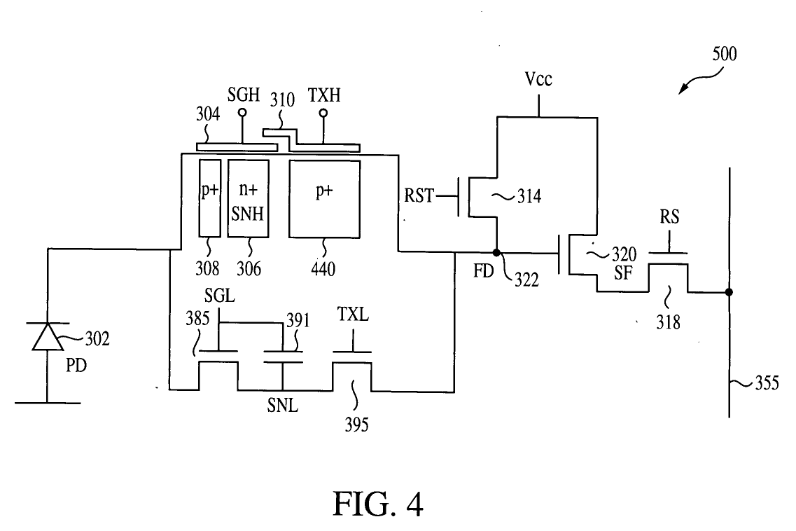

Each of the shutter gate transistors 387, 385 is coupled to a respective storage node 389, 391. The first storage node 389 is referred to as storage node high (SNH) and is used for low capacity, but high resolution, image captures. The second storage node 391 is referred to as storage node low (SNL) and is used in parallel with SNH for high capacity, but low resolution, image captures. While SNL is preferably a physical capacitor, SNH is preferably a gated storage node, as described more fully below in connection with FIG. 4.

Both SNH and SNL are coupled to respective transfer transistors 393, 395. Transfer transistor 393 is activated by signal TXH and transfer transistor 395 is activated by signal TXL. Both transfer transistors 393, 395 are coupled to floating diffusion region 322, which is in turn, coupled to reset transistor 314. Reset transistor 314 is activated by control signal RST, and is also coupled to source-follower transistor 320. Both reset transistor 314 and source-follower transistor 320 are coupled to source voltage terminal Vcc. Source-follower transistor 320 is also coupled to row select transistor 318, which when activated by signal RS, couples the pixel cell 400 to the column line 355 for readout.

During operation, charge generated by photodiode 302 is transferred to SNH 389. If charge still remains to be transferred from photodiode 302 because SNH 389 is at capacity, then SNL 391 stores the remainder of the charge. In accordance with an exemplary embodiment of the invention, all charge generated by photodiode 302 is captured and used to determine the level of the pixel signal, thereby increasing dynamic range and signal-to-noise ratios.

Referring to FIG. 4, a schematic diagram of a pixel cell 500 is depicted as containing two storage nodes SNH 306, SNL 391, where one of the storage nodes SNL 391 is made up of a storage node employing a physical capacitor and the other is a gated storage node 306. In all other aspects, pixel cell 500 is identical to pixel cell 400.

Gated storage node 306 is conductively coupled to a shutter gate transistor 304 activated by control signal SGH. Storage node 306 is also coupled between barrier region 308, p+ region 440 and transfer transistor 310. Barrier layer is, for example, a boron layer that is implanted between photodiode 302 and storage node 306 to control charge transference from photodiode 302 to storage node 306. Tying barrier region 308 to shutter gate transistor 304 decreases barrier region 308 and allows charge transfer from photodiode 302 to storage node 306 when shutter transistor 304 is activated by SGH. As depicted in FIG. 4, barrier region 308 and storage node 306 are made up of oppositely doped silicon. Exemplary structure and operation of pixels employing a gated storage node between a photodiode 302 and a floating diffusion region 322 is described in commonly-assigned application no. 10/XXX,XXX, filed ______, the entire content of which is incorporated herein by reference. Further, exemplary structure and operation of pixels employing a storage capacitor between a photodiode and a floating diffusion region is described in commonly assigned application no. 10/XXX,XXX, filed ______, the entire content of which is incorporated herein by reference.

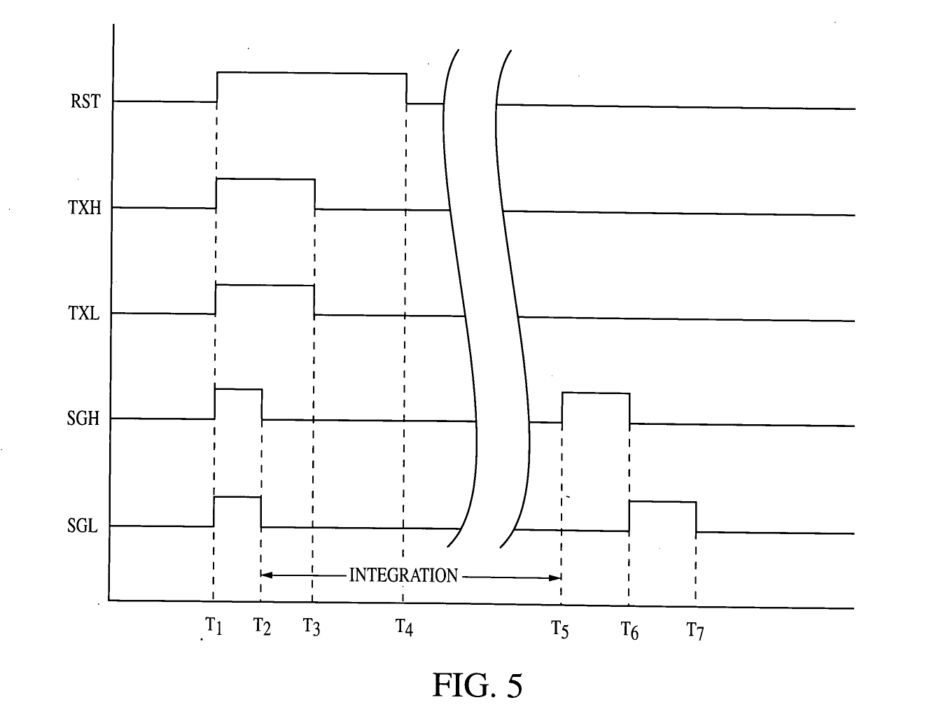

Turning to FIG. 5, a timing diagram is depicted as describing a charge collection operation of pixel cell 500, in accordance with an exemplary embodiment of the invention. At time T1, each of the depicted control signals (i.e., the reset control signal RST, the transfer high control signal TXH, the transfer low control signal TXL, the shutter gate high control signal SGH and the shutter gate low control signal SGL) are logic HIGH, thereby activating the reset transistor 314, both transfer transistors 310, 395 and both shutter gate transistors 304, 385. At this time, the photodiode 302, both storage nodes 306, 391 and the floating diffusion region 322 are exposed to the reset voltage (e.g., Vcc).

At time T2, control signals SGH and SGL both go logic LOW, thereby deactivating shutter gate transistors 304, 385 and resetting photodiode 302. Also at this time, the integration period begins and the photodiode 302 is exposed to incoming light. At time T3, control signals TXH and TXL both go logic LOW, thereby resetting storage nodes 306, 391. At time T4, RST goes logic LOW and the reset operation ends.

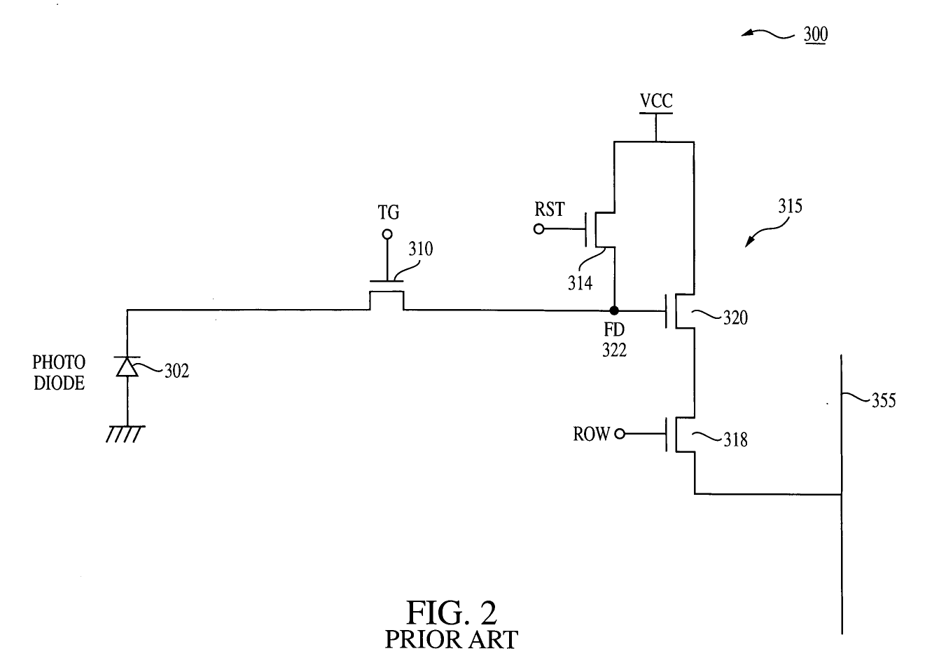

At time T5, control signal SGH is raised to logic HIGH and the charge generated by photodiode 302 is transferred to storage node 306, via shutter gate transistor 304. In accordance with an exemplary embodiment of the invention, at time T6, control signal SGH goes logic LOW and control signal SGL goes logic HIGH and any remainder charge due to storage node 306 being at capacity gets transferred to storage node 391. As a result, all of the charge generated by photodiode 302 is transferred to storage nodes 306 and 391, thereby increasing the dynamic range and having superior signal-to-noise ratios over the FIG. 2 pixel cell 300.

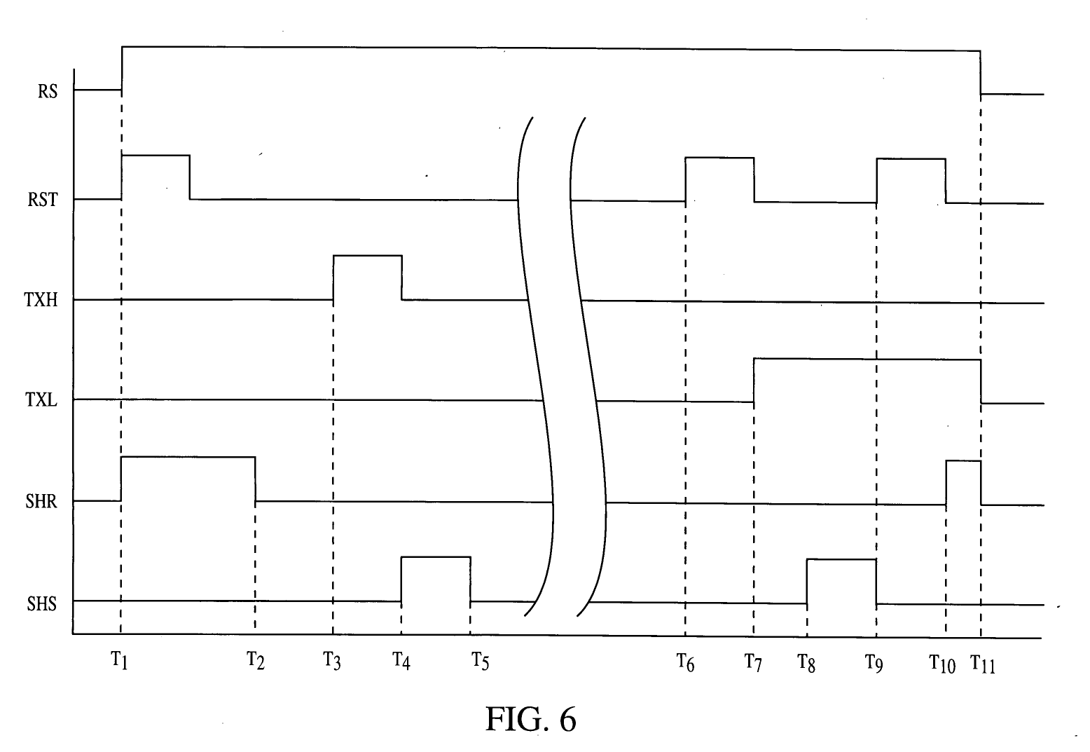

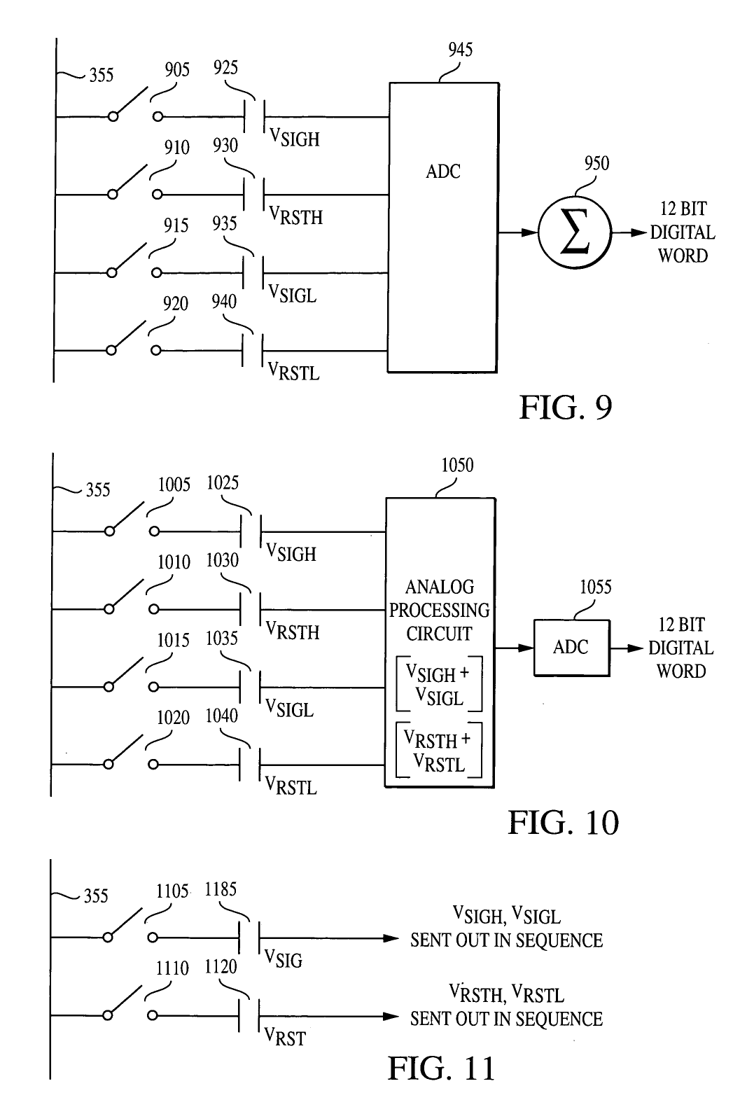

FIG. 6 depicts a timing diagram of a readout operation of pixel cell 500, in accordance with an exemplary embodiment of the invention. It is presumed for purposes of illustration that both storage nodes 306 and 391 are storing charge from photodiode 302. At time T1, control signal RST is cycled logic HIGH then LOW, thereby resetting the floating diffusion region 322. At the same time, T1, control signals RS and SHR both go logic HIGH and the reset voltage stored on the floating diffusion region 322 is read out to the column line 355 and transferred to a sample and hold circuit (such as, e.g., those described below in connection with FIGS. 9-11) until time T2, where control signal SHR goes logic LOW.

At time T3, control signal TXH goes logic HIGH and the charge stored on storage node 306 is transferred to the floating diffusion region 322 until time T4, where TXH goes logic LOW. Also, at time T4, control signal SHS goes logic HIGH; the charge stored on floating diffusion region 322 is transferred to column line 355 and transferred to a sample and hold circuit (such as, e.g., those described below in connection with FIGS. 9-11) until time T5, where control signal SHS goes logic LOW.

At time T6, control signal RST may be cycled logic HIGH thereby resetting the floating diffusion region 322. At time T7, control signal RST is cycled logic LOW and TXL is cycled logic HIGH; the charge stored on storage node 391 is transferred to the floating diffusion region 322. At time T8, control signals RS and SHS go logic HIGH and the charge stored at floating diffusion region 322 is transferred to column line 355 and to a sample and hold circuit (such as, e.g., those described below in connection with FIGS. 9-11) until time T9, where control signal SHS goes logic LOW.

Also at time T9, control signal RST is cycled logic HIGH and LOW, thereby resetting floating diffusion region 322 and SNL region 391. At time T10, control signal SHR goes logic HIGH and the reset voltage of the floating diffusion region 322 is read out onto column line 355 and into a sample and hold circuit (such as, e.g., those described below in connection with FIGS. 9-11), until time T11, where control signal SHR goes logic LOW.

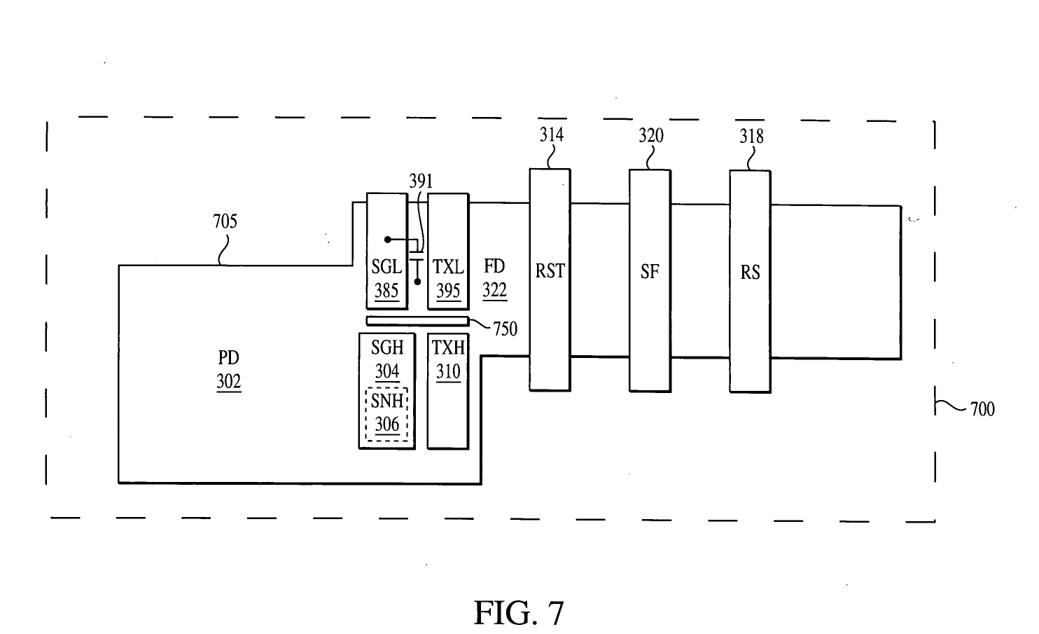

Turning now to FIG. 7, a plan view of the FIG. 4 pixel cell 500 on a substrate 705 is depicted in accordance with another exemplary embodiment of the invention. At the left-hand portion of FIG. 7, a photodiode 302 is depicted as being conductively coupled to both shutter gate transistors 304, 385. Gated storage node SNH 306 is depicted as being beneath the surface of the gate of shutter gate transistor 304 and transfer transistor 310 is electrically coupled to shutter gate transistor 304.

Adjacent to shutter gate transistor 304, and separated by separator region 750, and electrically coupled to the photodiode 302, is shutter gate transistor 385, which is, in turn, electrically coupled to both storage capacitor 391 and transfer transistor 395. Both transfer transistors 395 and 310 are electrically coupled to floating diffusion region 322.

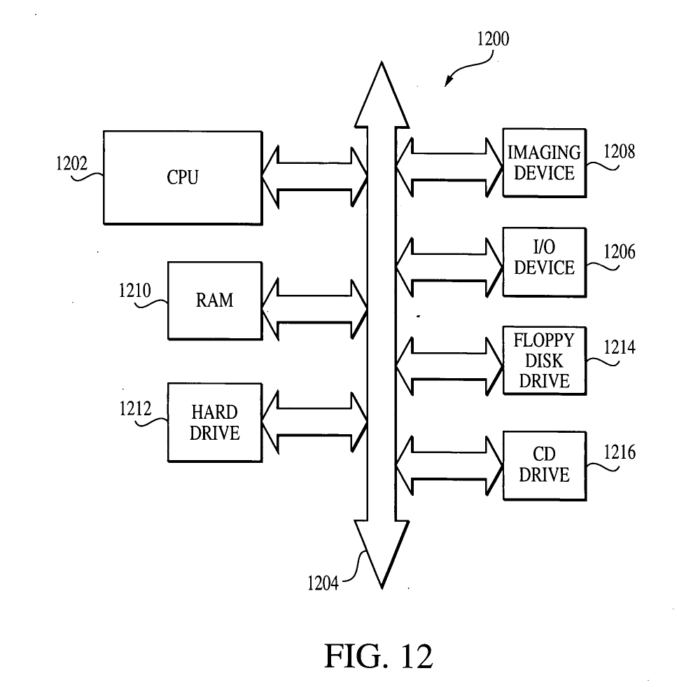

Also depicted at FIG. 7 are the readout portion of the pixel cell, including reset transistor 314, the source-follower transistor 320 and the row select transistor 318. Further, the substrate 705 is depicted as being part of a semiconductor chip 700 that may be incorporated into a processor based system, such as that described below in connection with FIG. 12.

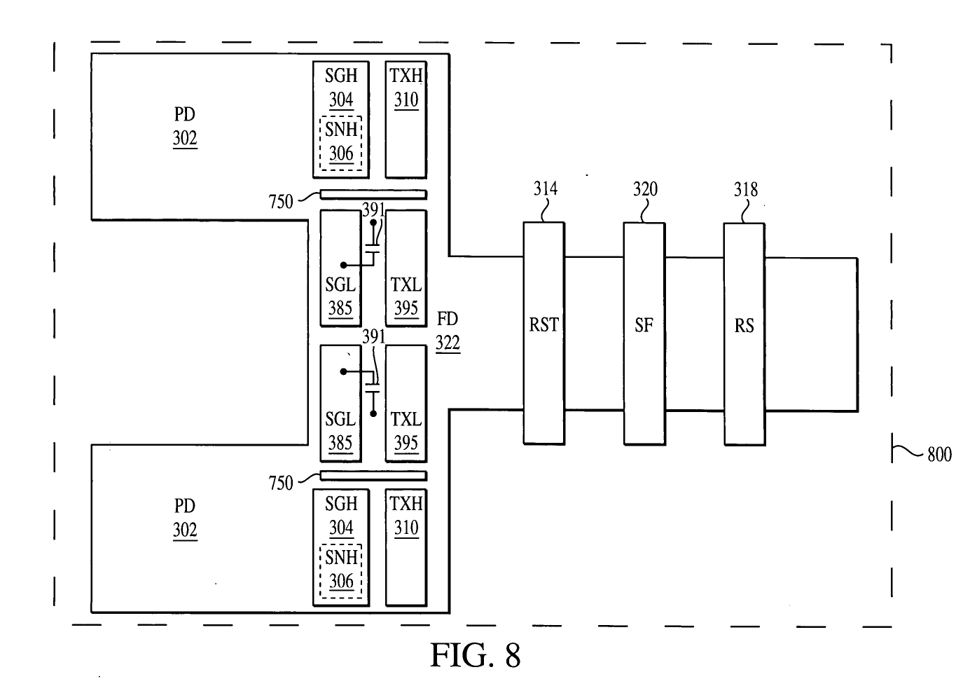

Turning to FIG. 8, a plan view of two pixel cells sharing a common floating diffusion region 322 and readout circuit is depicted in accordance with another exemplary embodiment of the invention. Each pixel cell has its own pair of shutter gate transistors 304, 385, its own pair of storage nodes 391, 306 and its own pair of transfer transistors 310, 395. However, in accordance with an exemplary embodiment of the invention, both pixels share a common floating diffusion region 322. In addition, both pixels share a common reset transistor 314, source-follower transistor 320 and row select transistor 318.

Charge is transferred and read out from the pixel cells of FIG. 8 as described in connection with the timing diagrams of FIGS. 5 and 6, however, each pixel cell is read out successively to a sample and hold circuit (such as, e.g., those described below in connection with FIGS. 9-11). In addition, the signals from the respective pixel cells may be combined or differentiated, as the specific application warrants. Similarly to the pixel cell of FIG. 7, the pixel cells of FIG. 8 are depicted as being part of a semiconductor chip 800 that may be incorporated into a processor based system.

Turning to FIG. 9, a sample and hold circuit is depicted in accordance with another exemplary embodiment of the invention. The left-hand portion of FIG. 9 depicts column line 355 which is coupled to the row select transistor 318 of pixel cell 500. As the pixel signals and reset signals are read out from the floating diffusion region 322, as described in connection with FIG. 6, they are transferred to an analog-to-digital converter (ADC) 945 via four separate switched conductive paths 905, 910, 915, 920 to respective storage capacitors 925, 930, 935, 940. From that point, the signals are transferred to digital summer 950 and summed to form a 12-bit output digital word.

FIG. 10 depicts a sample and hold circuit in accordance with another exemplary embodiment of the invention. The FIG. 10 sample and hold circuit is similar to the FIG. 9 sample and hold circuit in that there are four separate switched conductive paths 1005, 1010, 1015, 1020 receiving the pixel signals and reset signals from the floating diffusion region 322. In addition, each conductive path contains a separate storage capacitor 1025, 1030, 1035, 1040. However, in FIG. 10, the signals are combined in the analog domain (e.g., [VSIGH+VSIGL]−[VRSTH+VRSTL]) and then digitized by ADC 1055 to form a 12-bit digital word.

Turning to FIG. 11, a sample and hold circuit is depicted in accordance with yet another exemplary embodiment of the invention. Here, rather than having four separate conductive paths coupled to four separate storage capacitors, there are two switched conductive paths 1105, 1110 respectively coupled to two storage capacitors 1115, 1120. In this sample and hold circuit, the pixel signals (e.g., VSIGL and VSIGH) respectively stored by storage nodes 391, 306 (e.g., of FIG. 4) are read out to a common switched conductive path 1105, via column line 355, and successively stored on storage capacitor 1115. Similarly, the reset signals (e.g., VRSTL, VRSTH) are read out to a common switched conductive path 1110, and successively stored on storage capacitor 1120. From that point, the signals may be combined in either the digital domain (e.g., as in FIG. 9) or the analog domain (e.g., as in FIG. 10).

FIG. 12 depicts a block diagram of a processor based system 1200 that includes an imager device 1208 containing the semiconductor chip of either FIGS. 7 or 8. Processor based systems exemplify systems of digital circuits that could include an image sensor. Examples of processor based systems include, without limitation, computer systems, camera systems, scanners, machine vision systems, vehicle navigation systems, video telephones, surveillance systems, auto focus systems, star tracker systems, motion detection systems, image stabilization systems and others, any of which could utilize the invention.

System 1200 includes central processing unit (CPU) 1202 that communicates with various devices over bus 1204. Some of the devices connected to bus 1204 provide communication into and out of system 1200, illustratively including input/output (I/O) device 1206 and imager device 1208. Other devices connected to bus 1204 provide memory, illustratively including random access memory (RAM) 1210, hard drive 1212, and one or more peripheral memory devices such as floppy disk drive 1214 and compact disk (CD) drive 1216.

As described above, it is desirable to develop an improved pixel cell for use in an imager device having increased signal to noise ratios, and a larger charge storage capacity without increasing the size of the pixel cell. Exemplary embodiments of the present invention which accomplish these goals have been described in connection with the figures.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. For example, while FIG. 8 depicts two pixel cells sharing a common floating diffusion region 322, any number of pixel cells may share a common floating diffusion region. In addition, although the operation of FIG. 4 is described herein in connection with a specific timing diagram, it should be readily apparent that modifications may be made to such timing for purposes of practicing the invention. Further, while the invention is described in connection with 7-transistor pixel cells, the invention may be practiced with greater or fewer transistors in each pixel cell. In addition, while the invention is described in connection with a CMOS imager device, it can also be incorporated into a charge coupled device imager. Accordingly, the invention is not limited by the foregoing description or drawings, but is only limited by the scope of the appended claims.

1. A pixel cell, comprising:
a first storage node for storing charge generated at a photosensitive element prior to storing said charge at a floating diffusion region of said pixel cell; and
a second storage node for storing a portion of said charge generated by said photosensitive element that is not stored by said first storage node.

2. The pixel cell of claim 1, wherein said photosensitive element is a photodiode.

3. The pixel cell of claim 1, wherein said first storage node comprises a gated storage node.

4. The pixel cell of claim 1, wherein said first storage node comprises a storage capacitor.

5. The pixel cell of claim 1, wherein said second storage node comprises a gated storage node.

6. The pixel cell of claim 1, wherein said second storage node comprises a storage capacitor.

7. The pixel cell of claim 3, wherein said gated storage node comprises:
a depletion area between said photosensitive element and said floating diffusion region; and
a barrier region adjacent to said depletion area.

8. The pixel cell of claim 7, wherein said depletion area and said barrier region comprise oppositely doped silicon.

9. The pixel cell of claim 1 further comprising a first transfer transistor switchably coupled between at least one of said first and second storage nodes and said floating diffusion region.

10. The pixel cell of claim 1 further comprising:
a first transfer transistor switchably coupled between said first storage node and said floating diffusion region; and
a second transfer transistor switchably coupled between said second storage node and said floating diffusion region.

11. A semiconductor chip, comprising:
a plurality of pixel cells, each of said plurality of pixel cells comprising:
a first storage node for storing charge generated at a photosensitive element prior to storing said charge on a floating diffusion region of said pixel cell; and
a second storage node for storing a portion of said charge generated by said photosensitive element that is not stored by said first storage node.

12. The chip of claim 11, wherein said photosensitive element is a photodiode.

13. The chip of claim 11, wherein said first storage node comprises a gated storage node.

14. The chip of claim 11, wherein said first storage node comprises a storage capacitor.

15. The chip of claim 11, wherein said second storage node comprises a gated storage node.

16. The chip of claim 11, wherein said second storage node comprises a storage capacitor.

17. The chip of claim 13, wherein said gated storage node comprises:
a depletion area between said photosensitive element and said floating diffusion region; and
a barrier region adjacent to said depletion area.

18. The chip of claim 17, wherein said depletion area and said barrier region comprise oppositely doped silicon.

19. The chip of claim 11 further comprising a first transfer transistor switchably coupled between at least one of said first and second storage nodes and said floating diffusion region.

20. The chip of claim 11 further comprising:
a first transfer transistor switchably coupled between said first storage node and said floating diffusion region; and
a second transfer transistor switchably coupled between said second storage node and said floating diffusion region.

21. The chip of claim 11 further comprising a sample and hold circuit for receiving said charge stored by said floating diffusion region.

22. The chip of claim 21, wherein said sample and hold circuit comprises at least four storage nodes, each respectively for storing a reset voltage and a signal voltage representing a charge stored by each of said first and second storage nodes.

23. The chip of claim 21, wherein said sample and hold circuit further comprises at least two storage nodes for respectively storing a reset voltage of said floating diffusion region and a signal voltage of at least one of said first and second storage nodes.

24. A semiconductor chip, comprising:
a plurality of pixel cells, at least two of which share a common floating diffusion region, each of said at least two pixel cells further comprising:
a first storage node for storing charge generated at a photosensitive element prior to storing said charge on said common floating diffusion region; and
a second storage node for storing a portion of said charge generated by said photosensitive element that is not stored by said first storage node.

25. A method for operating an image sensor, the method comprising:
receiving, at a first storage node of a pixel cell, charge generated by a photosensitive element of said pixel cell;
receiving, at a second storage node of said pixel cell, a portion of said charge generated by said photosensitive element not stored at said first storage node; and
transferring said charge from at least one of said first and second storage nodes to a floating diffusion region of said pixel cell.

26. The method of claim 25, wherein said first act of receiving comprises receiving said charge at a gated storage node of said pixel cell.

27. The method of claim 25, wherein said second act of receiving comprises receiving said portion of said charge at a storage capacitor of said pixel cell.

28. The method of claim 25, wherein said act of transferring comprises:
transferring said charge from said first storage node to said floating diffusion region; and
transferring said charge from said floating diffusion region to a column line associated with said pixel cell.

29. The method of claim 25, wherein said act of transferring comprises:
transferring said charge from said second storage node to said floating diffusion region; and
transferring said charge from said floating diffusion region to a column line associated with said pixel cell.

30. The method of claim 25, wherein said first act of receiving comprises activating a shutter gate transistor coupled between said first storage node and said photosensitive element.

31. The method of claim 25, wherein said second act of receiving comprises activating a shutter gate transistor coupled between said second storage node and said photosensitive element.

32. The method of claim 25, wherein said act of transferring comprises activating a transfer transistor coupled between at least one of said first and second storage nodes and said floating diffusion region.

33. A method for operating an image sensor, the method comprising:
receiving light at a photosensitive element of a first pixel cell;
transferring charge generated by said photosensitive element to a first storage node of said first pixel cell;
transferring a portion of said charge not transferred to said first storage node to a second storage node of said first pixel cell;
transferring said charge from said first storage node to a floating diffusion region of said first pixel cell;
reading out said charge from said floating diffusion region;
transferring said charge from said second storage node to said floating diffusion region; and
reading out said charge from said floating diffusion region.

34. The method of claim 33 further comprising the act of resetting at least one of said photosensitive element and said floating diffusion region.

35. The method of claim 33 further comprising:
receiving light at a second photosensitive element of a second pixel cell;
transferring charge generated by said second photosensitive element to a first storage node of said second pixel cell;
transferring a portion of said charge not transferred to said first storage node of said second pixel cell to a second storage node of said second pixel cell;
transferring said charge from said first storage node of said second pixel cell to said floating diffusion region, wherein said first and second pixel cells share said floating diffusion region;
reading out said charge from said floating diffusion region;
transferring said charge from said second storage node of said second pixel cell to said floating diffusion region; and
reading out said charge from said floating diffusion region.

36. A processor system, comprising:
a processor; and
an imager device coupled to said processor, said imager device having an array of pixel cells, each pixel cell comprising:
a first storage node for storing charge generated at a photosensitive element prior to storing said charge at a floating diffusion region of said pixel cell; and
a second storage node for storing a portion of said charge generated by said photosensitive element that is not stored by said first storage node.

37. The processor system of claim 36, wherein said photosensitive element is a photodiode.

38. The processor system of claim 36, wherein said first storage node comprises a gated storage node.

39. The processor system of claim 36, wherein said first storage node comprises a storage capacitor.

40. The processor system of claim 36, wherein said second storage node comprises a gated storage node.

41. The processor system of claim 36, wherein said second storage node comprises a storage capacitor.

42. The processor system of claim 38, wherein said gated storage node comprises:
a depletion area between said photosensitive element and said floating diffusion region; and
a barrier region adjacent to said depletion area.

43. The processor system of claim 42, wherein said depletion area and said barrier region comprise oppositely doped silicon.

44. The processor system of claim 36, wherein each pixel cell further comprises a first transfer transistor switchably coupled between at least one of said first and second storage nodes and said floating diffusion region.

45. The processor system claim 36, wherein each pixel cell further comprises:
a first transfer transistor switchably coupled between said first storage node and said floating diffusion region; and
a second transfer transistor switchably coupled between said second storage node and said floating diffusion region.
